(19) United States
(12) Patent Application Publication
(10) Pub. No.: US 2026/0089598 A1
(43) Pub. Date: Mar. 26, 2026

(54) SYSTEM FOR INTEGRATING HETEROGENEOUS WIRELESS NETWORKS, EDGE-COMPUTING APPARATUS AND METHOD FOR OPERATING THE SAME

(71) Applicants: Z-COM, INC., Hsinchu (TW); National Yang Ming Chiao Tung University, Hsinchu City (TW)

(72) Inventors: Chia-Fang Wu, Hsinchu (TW); Liang-Shu Hsu, Hsinchu (TW); Chi-Yu Li, Hsinchu City (TW); TAN-TAI PHAN, Hsinchu City (TW)

(21) Appl. No.: 19/339,243

(22) Filed: Sep. 24, 2025

Related U.S. Application Data
(60) Provisional application No. 63/698,570, filed on Sep. 25, 2024.

(51) Int. Cl. H04W 36/30; H04W 4/44

(52) U.S. Cl. CPC H04W 36/302; H04W 4/44

(57) ABSTRACT

A system for integrating heterogeneous wireless networks, an edge-computing device, and a method for operating the same. The system includes an in-vehicle device installed in a vehicle and an edge-computing device installed in a vehicle station. The in-vehicle device generates streaming data to be transmitted via heterogeneous wireless networks. When the vehicle approaches the vehicle station, the in-vehicle device performs a handover process in response to a signal strength indicator for switching connectivity between the in-vehicle device and the edge-computing device. The edge-computing device uses a switch to perform network convergence while receiving heterogeneous wireless networking data, and uses a streaming proxy to perform source switching on the converged data received from the switch without interruption during the handover process.

### CROSS-REFERENCE TO RELATED PATENT APPLICATION

This application claims the benefit of priority to U.S. Provisional Patent Application No. 63/698,570, filed on Sep. 25, 2024, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a solution for providing a smooth video streaming service during a handover process, and more particularly to a system for integrating heterogeneous wireless networks, an edge-computing apparatus and a method for operating the same.

### BACKGROUND OF THE DISCLOSURE

In the 5th-generation mobile communication technology (5G) standard, integration of heterogeneous wireless networks (such as Wi-Fi™ and 5G) is primarily based on a 5G core network and related functionalities, including all communication protocols related to non-3GPP heterogeneous networks.

Conventionally, Wi-Fi™ and 4G/5G wireless networks have been considered as two independent networks with no integration. In general, a switching operation between the two independent networks can be managed by a terminal device based on a connection status there-between. While conventional technologies may allow a telecom operator to integrate the heterogeneous wireless networks, e.g., the Wi-Fi™ and 4G/5G wireless networks, through customized solutions with the terminal device, these solutions still rely on the connection status to conduct the switching there-between.

Nevertheless, the integration of heterogeneous networks within the core network, such as the 5G core network, may lead to excessive handover delays, which could negatively impact application-layer performance, e.g., delaying multimedia streaming or interruption during handover. Furthermore, making an existing network (e.g., the 5G core network) to support integration of heterogeneous networks, such as adding to Wi-Fi™ network to the 5G core network, is challenging and prone to result in significant cost increases when modifying the existing network infrastructure.

### SUMMARY OF THE DISCLOSURE

In response to the above-referenced technical inadequacies, the present disclosure provides a system for integrating heterogeneous wireless networks, an edge-computing device, and a method for operating integration of heterogeneous wireless networks.

In one aspect, the system for integrating heterogeneous wireless networks includes an in-vehicle device installed in a vehicle and an edge-computing device that can be installed in a vehicle station. The in-vehicle device is configured to perform a handover process, for example, when the vehicle approaches the vehicle station, in response to a signal strength indicator between a first wireless connectivity being established for transmitting a first wireless networking data to the edge-computing device via a wireless access point and a second wireless connectivity being established for transmitting a second wireless networking data to a mobile core control plane network via a mobile base station.

The edge-computing device includes a switch that is configured to receive the first wireless networking data via a first wireless network interface and shift the second wireless networking data via a shifted connectivity to the edge-computing device from the mobile core control plane network via a second wireless network interface. The switch performs network convergence on the first wireless networking data and the second wireless networking data so as to obtain a converged data. The edge-computing device includes a streaming proxy coupled with the switch. The streaming proxy is configured to perform source switching on the converged data received from the switch without interruption during the handover process, by assigning a common IP address to the converged data. The edge-computing device includes a data bank that is used to store the converged data with the common IP address.

In one aspect, the switch is configured to shift the second wireless networking data to the edge-computing device via the second wireless network interface when the vehicle approaches the vehicle station.

Further, the second wireless network interface is implemented by a mobile data plane that is configured to shift the second wireless networking data to the edge-computing device from the mobile core control plane network.

In one further aspect, the in-vehicle device includes a handover controller that performs the handover process between the first wireless connectivity and the second wireless connectivity in response to the signal strength indicator that is generated by detecting signal strength between the in-vehicle device and the wireless access point or the mobile base station.

The switch can continuously receive both the first wireless networking data and the shifted second wireless networking data during the handover process, since the first wireless connectivity and the shifted connectivity between the in-vehicle device and the edge-computing device coexist when the handover process is performed.

In one embodiment of the present disclosure, the first wireless networking data is a first type of streaming packets being encapsulated in compliance with a first communication protocol, and the second wireless networking data is a second type of streaming packets being encapsulated in compliance with a second communication protocol, in which the first communication protocol and the second communication protocol are heterogeneous wireless network protocols.

Further, the switch can be a software-defined networking switch that is configured to process heterogeneous wireless networking data.

In one aspect, in the method for operating integration of heterogeneous wireless networks, the in-vehicle device performs a handover process when receiving data generated by one or more peripheral devices installed in a vehicle, and a second wireless connectivity with a mobile base station is established for transmitting the data or a minority of items of data to a mobile core control plane network. In the handover process, the second wireless connectivity can be switched to a first wireless connectivity in response to a signal strength indicator indicating that signal strength of the first wireless connectivity is higher than a preset threshold or signal strength of the second wireless connectivity. The data is transmitted to the edge-computing device over the first wireless connectivity. In the edge-computing device, a switch receives the first wireless networking data via a first wireless network interface and shifts the second wireless networking data via a shifted connectivity to the edge-computing device from the mobile core control plane network via a second wireless network interface. In the switch, network convergence is performed on the first wireless networking data and the second wireless networking data so as to obtain a converged data. In a streaming proxy, source switching is performed on the converged data received from the switch without interruption during the handover process by assigning a common IP address to the converged data. Further, the converged data with the common IP address can be stored into a data bank.

These and other aspects of the disclosure will become apparent from the following description of the embodiments taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram depicting a system for integrating heterogeneous wireless networks according to one embodiment of the present disclosure;

FIG. 2 is a schematic diagram illustrating function an in-vehicle device and its connections with peripherals according to one embodiment of the present disclosure;

FIG. 3 is a block diagram illustrating components and functions of an edge-computing device according to one embodiment of the present disclosure;

FIG. 4 is a schematic diagram depicting a circumstance where a bus carrying the in-vehicle device approaches a bus station installed with the edge-computing device according to one of certain embodiments of the present disclosure;

FIG. 5 is a schematic diagram depicting another circumstance where a boat carrying the in-vehicle device approaches a wharf installed with the edge-computing device according to another embodiment of the present disclosure;

FIG. 6 is a flowchart illustrating a handover process preformed between heterogeneous wireless networks according to one embodiment of the present disclosure; and

FIG. 7 is a flowchart illustrating steps of network convergence and source switching preformed on converged heterogeneous wireless networking data according to one embodiment of the present disclosure.

### DETAILED DESCRIPTION OF THE EXEMPLARY EMBODIMENTS

The disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The present disclosure relates to a system for integrating heterogeneous wireless networks, an edge-computing device of the system, and a method for operating integration of heterogeneous wireless networks. In an aspect of the present disclosure, the system achieves a solution for integrating heterogeneous wireless networks such as a WiFi™ network and a 4G/5G network that are regarded as two independent networks, and the system can be implemented by a system on a chip, a circuitry, a computer system including one or more processors and a memory, or software programs performed in an electronic device.

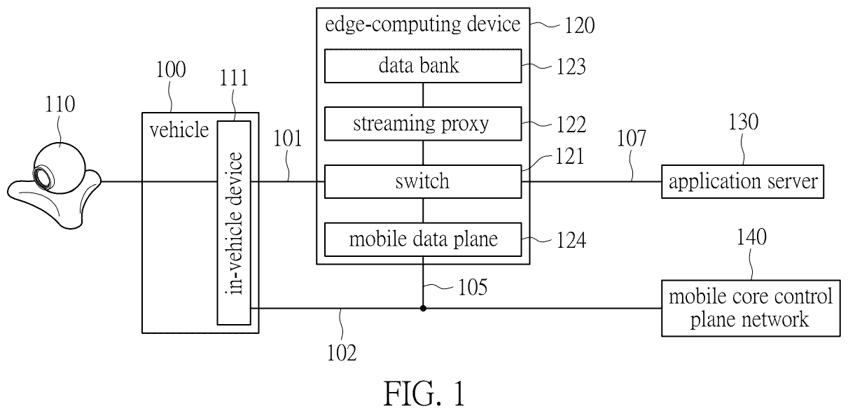

Reference is made to FIG. 1, which is a schematic diagram depicting a system for integrating heterogeneous wireless networks according to one embodiment of the present disclosure.

In the system, an in-vehicle device 111 is provided to be installed in a vehicle 100, e.g., a bus, a train, a boat or an aircraft. The in-vehicle device 111 is configured to collect data generated inside the vehicle 100; for example, the data can be generated by one or more peripheral devices 110 installed in the vehicle 100. The one or more peripheral devices 110 are exemplarily one or more surveillance cameras that are installed at multiple locations in the vehicle 100 and can be used to record events occurring around the vehicle 100. For example, the one or more surveillance cameras can be used to capture moving images around and inside the vehicle 100 and can be stored inside the in-vehicle device 111 or transmitted to an external server by a streaming method.

In a scenario, when the vehicle 100 travels on a road or over a sea, the in-vehicle device 111 installed in the vehicle 100 generally establishes a second wireless connectivity 102 for transmitting a second wireless networking data to a mobile core control plane network 140 via a mobile base station (not shown in this diagram). It should be noted that the in-vehicle device 111 can periodically detect whether or not a handover process needs to be initiated based on a kind of signal strength indicator such as a received signal strength indicator (RSSI) that measures powers of received radio signals between the in-vehicle device 111 and a wireless access point (AP) or a mobile base station. When the vehicle 100 approaches the vehicle station, other than the second wireless connectivity 102, a first wireless connectivity 101 between the in-vehicle 111 and an edge-computing device 120 can be established. In the meantime, the in-vehicle device 111 initiates the handover process in response to the signal strength indicator between the first wireless connectivity 101 being established for transmitting one of the heterogeneous wireless networking data, e.g., a first wireless networking data, to the edge-computing device 120 via the wireless access point and the second wireless connectivity 102 being established for transmitting another one of the heterogeneous wireless networking data, e.g., the second wireless networking data, to the mobile core control plane network 140 via the mobile base station.

In the system, the edge-computing device 120 is provided to be installed at a fixed site that can be a vehicle station serving the vehicle 100 to dock. For example, the vehicle station can be a bus station for docking the bus, a railway platform acting as a stop for the train, a wharf for docking the boat, or an airport apron where the aircraft is parked.

According to certain embodiments of the present disclosure, the edge-computing device 120 can be implemented by a computer system or a network facility that serves as a middlebox, which is a networking device that is configured to transform, inspect, and manage network packets being transmitted between sources and destinations. In an aspect, the functional components of the edge-computing device 120 can be implemented through collaboration of hardware and software. The edge-computing device 120 essentially includes a switch 121 and a streaming proxy 122.

In one of the embodiments, the switch 121 can be a software-defined networking (SDN) switch that is configured to process heterogeneous wireless networking data. Through the switch 121 of the edge-computing device 120, the first wireless connectivity 101 with the in-vehicle device 111 is established for transmitting the first wireless networking data when the vehicle 100 approaches the vehicle station, and in the meantime the in-vehicle device 111 initiates the handover process. In the handover process, the switch 121 continuously receives both the first wireless networking data and the second wireless networking data, in which the first wireless networking data can be transmitted from the in-vehicle device 111 to the edge-computing device 120 via the first wireless connectivity 101, and a shifted connectivity 105 is also established by a mobile data plane 124 of the edge-computing device 120 between the in-vehicle device 111 and the edge-computing device 120 while the mobile data plane 124 shifts the second wireless networking data to the edge-computing device 120. Specifically, the shifted connectivity 105 is established to shift the second wireless networking data or minority of items of the second wireless networking data to the edge-computing device 120 from the mobile core control plane network 140 via a second wireless network interface. According to one of the embodiments of the present disclosure, the second wireless network interface is implemented by the mobile data plane 124 that functions as a user plane function (UPF) being configured to shift the second wireless networking data to the edge-computing device 120 from the mobile core control plane network 140.

Furthermore, the streaming proxy 122 of the edge-computing device 120 is coupling with the switch 121 and can be used to perform source switching on a converged data that converges the heterogeneous wireless networking data (e.g., the first wireless networking data and the second wireless networking data) that are originally assigned with at least two IP addresses received from the switch 121. In one of the embodiments, the streaming proxy 122 performs source switching on the converged data without interruption during the above-mentioned handover process initiated by the in-vehicle device 111 by assigning a common IP address to the converged data.

Still further, the edge-computing device 120 provides a data bank 123 that is configured to store the converged data with the common IP address from the streaming proxy 122. According to one embodiment of the present disclosure, the converged data can be stored internally or transmitted to an external device, i.e., an application server 130. For example, the data bank 123 implements a video server in the edge-computing device 120 for receiving the converged data with a streaming data when the vehicle 100 approaches the vehicle station. Alternatively, the converged data can also be delivered to the application server 130 via a data streaming connectivity 107.

According to certain embodiments of the present disclosure, as shown in the diagram, the system that includes the in-vehicle device 111 and the edge-computing device 120 is configured to integrate heterogeneous wireless networks that can be representative of, but not limited to, a first wireless network and a second wireless network. For example, the data generated inside the in-vehicle device 111 can be separated into at least two types of heterogeneous wireless networking data, e.g., the first wireless networking data that is a first type of streaming packets being encapsulated in compliance with a first communication protocol and the second wireless networking data that is a second type of streaming packets being encapsulated in compliance with a second communication protocol. It should be noted that the first communication protocol and the second communication protocol are heterogeneous wireless network protocols. In an exemplary example, the first communication protocol can be a WiFi™ standard network protocol and the second communication protocol can be a cellular communication protocol, such as a 4th-generation (4G) or 5th-generation (5G) mobile communication technology standard.

As described above, the system for integrating the heterogeneous wireless networks of the present disclosure is to integrate data streams of the first communication protocol (e.g., Wi-Fi™) and the second communication protocol (e.g., 4G/5G) through the switch 121 (e.g., the software-defined networking (SDN) switch). It should be noted that the in-vehicle device 111 establishes the second wireless connectivity for transmitting the data or a minority of items of data to the mobile core control plane network 140 via the mobile base station (not shown in the diagram), and the edge-computing device 120 introduces a user plane function (e.g., 5G UPF) for shifting the second wireless networking data (e.g., 5G data streams) via the shifted connectivity 105 so as to decapsulate the second wireless networking data and convert the data into the packets with the same protocol of the first wireless network data. For example, while the 5G packets can be decapsulated and converted into standard IP network packets (i.e., WiFi™ wireless packets), seamless switching between Wi-Fi and 5G data streams via the SDN switches can be achieved.

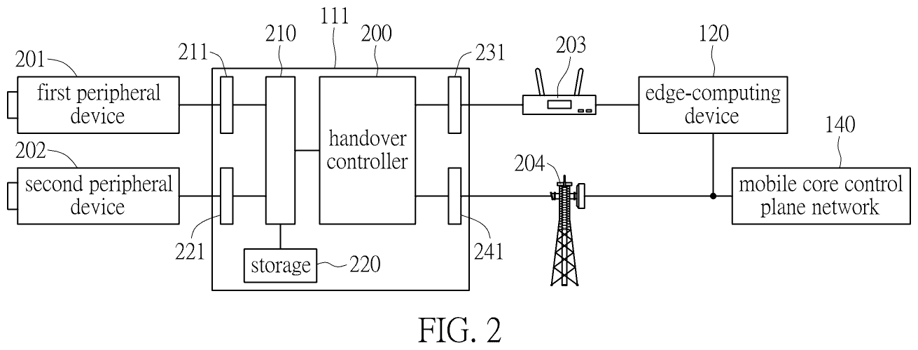

FIG. 2 is a schematic diagram illustrating function the in-vehicle device and its connections with peripherals according to one embodiment of the present disclosure.

The in-vehicle device 111 is configured to be installed in a vehicle and one or more peripheral devices (e.g., a first peripheral device 201 and a second peripheral device 202) are disposed at different positions in the vehicle. Main components of the in-vehicle device 111 can be implemented through collaboration of hardware and software and essentially includes a handover controller 200, an in-vehicle controller 210 and storage 220. In certain embodiments of the present disclosure, the handover controller 200 is configured to initiate a handover process over a first connection interface 231 and a second connection interface 241 that establish two connections with a wireless access point 203 and a mobile base station 204 respectively. The in-vehicle controller 210 is used to control operations of one or more peripheral devices (e.g., a first peripheral device 201 and a second peripheral device 202) and receive data generated by the one or more peripheral devices via a first peripheral interface 211 and a second peripheral interface 221 respectively. The in-vehicle controller 210 can temporarily store the received data into storage 220.

In a scenario, the first peripheral device 201 and the second peripheral device 202 are assigned with two different local IP addresses, by which the data generated by the first peripheral device 201 and the second peripheral device 202 can be transmitted to the in-vehicle device 111 with the standard IP network packets via the first peripheral interface 211 and the second peripheral interface 221 respectively. The data can be initially processed by the in-vehicle controller 210 and temporarily stored in the storage 220 of the in-vehicle device 111.

For example, the first peripheral device 201 and the second peripheral device 202 can be sensors (e.g., image sensors or cameras) installed in the vehicle for generating surveillance data relating to events occurring to the vehicle. The data generated by the sensors can be stored in the storage 220 or can be transmitted to outside via the first connection interface 231 or the second connection interface 241 with a streaming data.

In certain embodiments of the present disclosure, the in-vehicle device generally 111 establishes a second wireless connectivity with a mobile base station 204 for transmitting the data generated by the one or more peripheral devices or a minority of items of the data to the mobile core control plane network 140.

According to one embodiment of the present disclosure, the handover controller 200 is configured to perform the handover process between a first wireless connectivity that is used to connect with the wireless access point 203 and a second wireless connectivity that is used to connect with the mobile base station 204 in response to a signal strength indicator that is mentioned above as a received signal strength indicator (RSSI). The signal strength indicator indicates signal strengths to be detected over the connections between the in-vehicle device 111 and the wireless access point 203 and between the in-vehicle device 111 and the mobile base station 204. Accordingly, the signal strength is referred to for the handover process to operate.

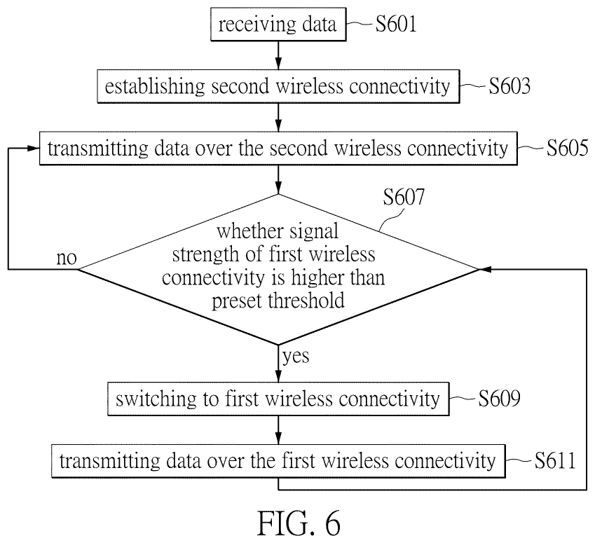

Reference is made to FIG. 6, which is a flowchart illustrating the handover process preformed between heterogeneous wireless networks according to one embodiment of the present disclosure.

The in-vehicle device generally receives data generated by one or more peripheral devices installed in the vehicle (step S601) and can transmit the data or minority of items of the data (e.g., information relating to the in-vehicle device or the data) to the mobile core control plane network via the mobile base station via the second wireless connectivity being established there-between (step S603). While the data or the information is continuously or periodically transmitted to the mobile core control plane network via the mobile base station (step S605), the in-vehicle device also continuously detects the signal strength between the in-vehicle device and any of connected mobile base stations and also the signal strength with any of networking devices, e.g., the wireless access point installed in the vehicle device. Other than the second wireless connectivity, the handover controller of the in-vehicle device initiates the handover process and accordingly determines whether the signal strength of the first wireless connectivity that is established between the in-vehicle device and the wireless access point of the vehicle station is higher than the currently-established second wireless connectivity or a preset threshold (step S607). It should be noted that the handover process can be initiated when the vehicle approaches the vehicle station within a specific signaling range where the WiFi™ signals can be received, as well as the first wireless connectivity also being established at the same time.

If a signal strength indicator indicates that the signal strength of the first wireless connectivity is not higher than the second wireless connectivity or not higher than the preset threshold (represented by “no”), the data generated by the one or more peripheral devices in the vehicle can still be transmitted over the second wireless connectivity (step S605).

On the contrary, if the signal strength indicator indicates that the signal strength of the first wireless connectivity is higher than the second wireless connectivity or higher than the preset threshold (represented by “yes”), the in-vehicle device switches the second wireless connectivity to the first wireless connectivity with the wireless access point in response to the signal strength indicator (step S609).

After the in-vehicle device switches to use the first wireless connectivity with the wireless access point, the data can be transmitted to the edge-computing device over the first wireless connectivity (step S611). The in-vehicle device will still proceed to perform the step S607 for determining whether to switch back to the second wireless connectivity in response to the signal strength indicator. For example, when the vehicle leaves for a next station from the current vehicle station, the in-vehicle device can switch to use the second wireless connectivity to transmit the data to the mobile core control plane network via a next mobile base station.

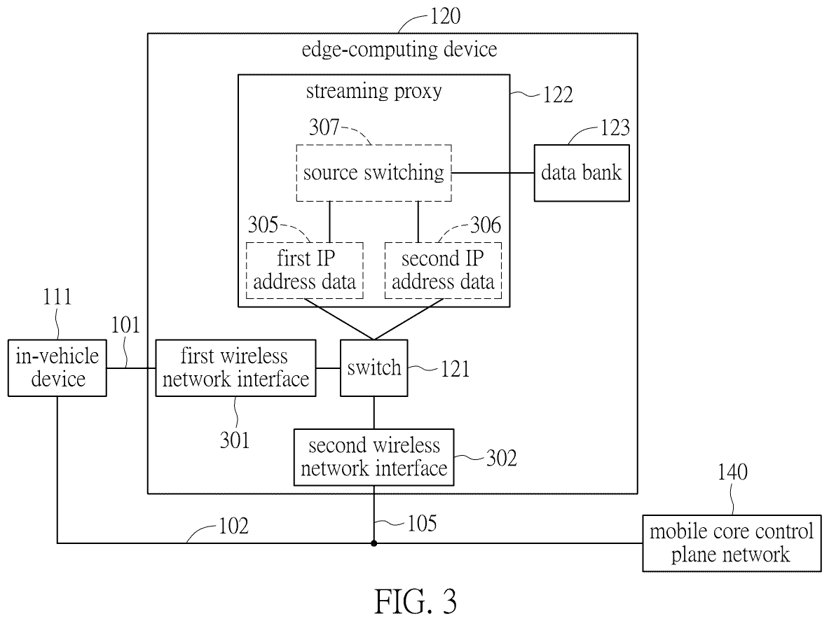

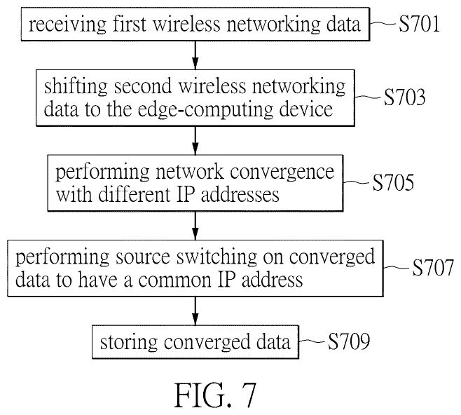

When the vehicle approaches or reaches the vehicle station, the connection over the first wireless connectivity between the in-vehicle device and the edge-computing device is established and can be used to transmit the data generated by the one or more peripheral devices in the vehicle to the edge-computing device. The operating functions of the edge-computing device can be understood by referring to a block diagram shown in FIG. 3 according to one embodiment of the present disclosure and referring to FIG. 7, which is a flowchart illustrating the method for operating integration of heterogeneous wireless networks according to one embodiment of the present disclosure, by which the steps of network convergence and source switching preformed on converged heterogeneous wireless networking data by the edge-computing device are described.

When the signal strength indicator indicates the signal strength of the first wireless connectivity 101 is higher than the preset threshold or the second wireless connectivity 102, the handover process will be initiated by the in-vehicle device 111 in response to the signal strength indicator and the second wireless connectivity 102 is switched to the first wireless connectivity 101 for transmitting the data generated by the one or more peripheral devices in the vehicle (i.e., a first wireless networking data) to the edge-computing device 120 via the wireless access point.

When the switch 121 of the edge-computing device 120 receives the first wireless networking data via a first wireless network interface 301 over the first wireless connectivity 101 (step S701), and, in the meantime, the switch 121 shifts the second wireless networking data by a shifted connectivity 105 to the edge-computing device 120 from the mobile core control plane network 140 via a second wireless network interface 302 (step S703). Accordingly, during the handover process, the switch 121 continuously receives both the first wireless networking data and the second wireless networking data since both the first wireless connectivity and the shifted connectivity between the in-vehicle device and the edge-computing device coexist. It should be noted that the second wireless network interface 302 is implemented by the mobile data plane 124 that is configured to shift the second wireless networking data to the edge-computing device 120 from the mobile core control plane network 140.

Next, in the switch 121, network convergence is performed on the both first wireless networking data that is received via the first wireless network interface 301 and the second wireless networking data that is shifted by the shifted connectivity 105 via the second wireless network interface 302 so that the switch 121 obtains a converged data (step S705).

After that, the streaming proxy 122 of the edge-computing device 120 receives the first wireless networking data and the second wireless networking data are originally assigned with different IP addresses from the switch 121. Therefore, the streaming proxy 122 receives a first IP address data 305 and a second IP address data 305, and then performs source switching 307 on the converged data by assigning a common IP address thereto (step S707).

In a scenario, the converged data with the common IP address is stored to the data bank 123 (step S709). It should be noted that, in the streaming proxy 122 of the edge-computing device 120, the source switching 307 is performed on the converged data received from the switch 121 and the converged data is assigned with the common IP address, so that the edge-computing device 120 can receive the streaming data (i.e., the converged data including the first wireless networking data with a first IP address and the second wireless networking data with a second IP address) without interruption even during the handover process performed by the in-vehicle device 111.

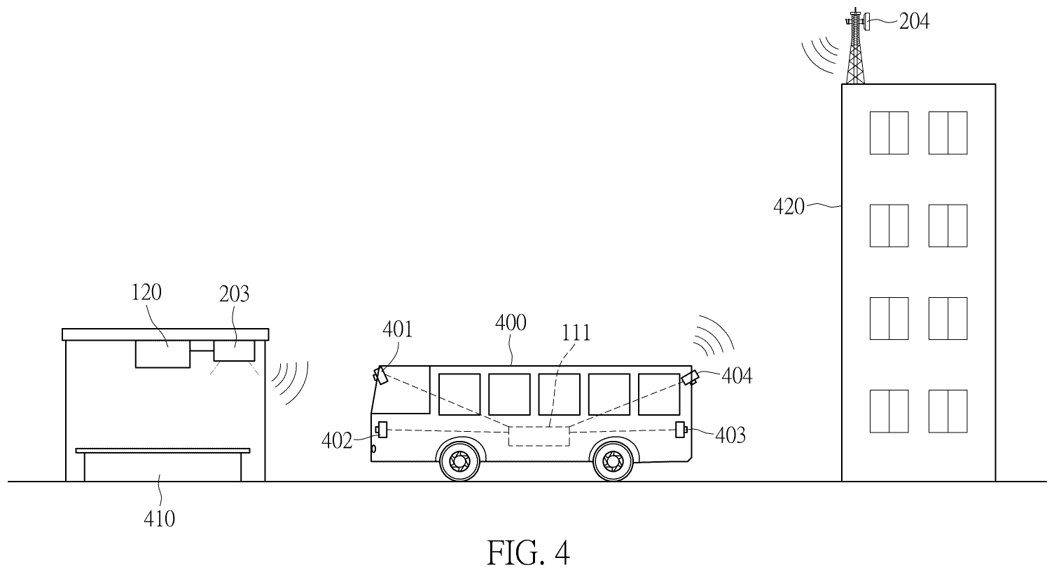

The above-described system can be applied to many applications, for example, referring to FIG. 4, which is a schematic diagram depicting a circumstance that a bus carrying the in-vehicle device approaches a bus station installed with the edge-computing device according to one of certain embodiments of the present disclosure.

As shown in the diagram, the edge-computing device 120 and a wireless access point 203 are installed in a bus station 410 and the edge-computing device 120 can receive data via the wireless access point 203. The in-vehicle device 111 is installed in a bus 400 and is configured to receive the data generated by a plurality of peripheral devices 401, 402, 403 and 404.

When the bus 400 travels on the road, the in-vehicle device 111 can transmit the data generated in the bus 400 or information thereof to the mobile core control plane network via the mobile base station 204 (over the above-mentioned second wireless connectivity) that is installed at a public place such as the top of a building 420. In addition to transmitting the data to the mobile core control plane network via the mobile base station 204, the data can also be temporarily stored in the storage (may be with limited storage space) inside the bus 400.

As described above, when the bus 400 having the in-vehicle device 111 approaches the bus station 410 having the edge-computing device 120 and the wireless access point 203, the handover process performed in the in-vehicle device 111 can switch the connection from the second wireless connectivity to the first wireless connectivity being established for connecting with the wireless access point 203. Therefore, the data generated and stored in the bus 400 can be transmitted to and backed up in the edge-computing device 120 installed in the bus station 410 since the edge-computing device 120 provides a backup solution being sufficient to back up a large amount of data.

The first wireless connectivity will be maintained until the bus 400 leaves the bus station 410 and reaches a place out of a signal coverage area of the wireless access point 203, and then the first wireless connectivity will be switched to the second wireless connectivity by the handover process.

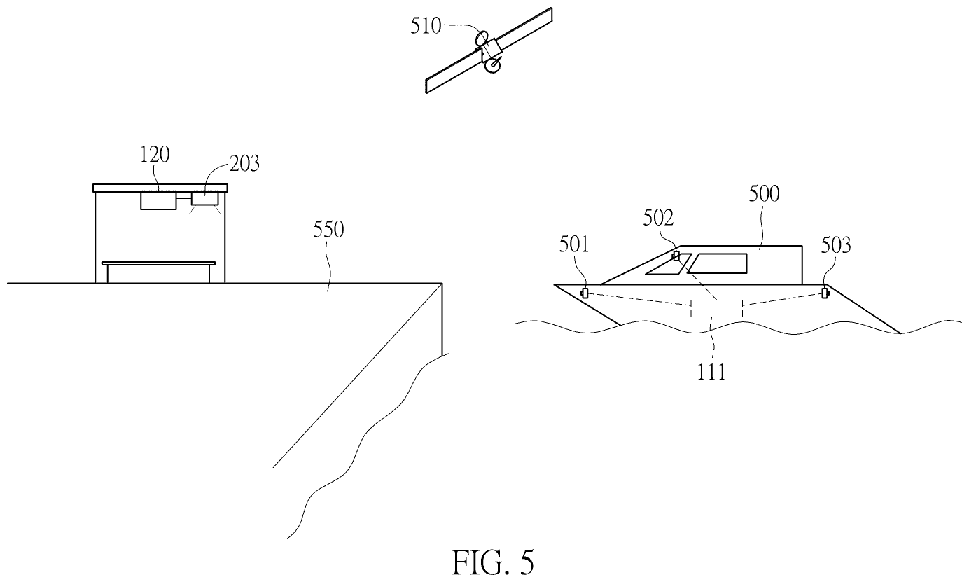

Reference is next made to FIG. 5, which is a schematic diagram depicting another circumstance applying the system for integrating heterogeneous wireless networks that a boat carrying the in-vehicle device approaches a wharf installed with the edge-computing device according to another embodiment of the present disclosure.

The edge-computing device 120 and the wireless access point 203 are installed on a wharf 550, and the in-vehicle device 111 is installed in a boat 500. The in-vehicle device 111 relies on a satellite 510 to establish the above-mentioned second wireless connectivity for connecting with the mobile core control plane network.

The in-vehicle device 111 receives the data generated by the peripheral devices 501, 502 and 503. The data can either be stored to storage installed in the boat 500 or transmitted to the mobile core control plane network via the satellite 510 via a second wireless connectivity. When the boat 500 approaches the wharf 550, the first wireless connectivity between the in-vehicle device 111 and the wireless access point 203 on the wharf 500 is established by the handover process initiated in the in-vehicle device 111. Thus, the data can be transmitted to the edge-computing device 120 via the first wireless connectivity until the first wireless connectivity is switched to the second wireless connectivity when the boat 500 leaves the wharf 550.

According to the above embodiments of the system for integrating heterogeneous wireless networks, the edge-computing device, and the method for operating the system of the present disclosure, the edge-computing device implements an edge computing platform by shifting the second wireless networking data with user plane function (e.g., 5G UPF) from the mobile core control plane network to the edge-computing platform. Without requiring upgrades to other core network functions, integration of the heterogeneous wireless networks can still be achieved while coexisting the first wireless connectivity and the second wireless connectivity.

Furthermore, in the edge-computing platform, a switch is configured to continuously receive data from all of the heterogeneous wireless networks and forward the converged data with a common IP address to an application server even through the received data are originally assigned with different source IP addresses. Accordingly, the system ensures that, even if the in-vehicle device performs the handover process among heterogeneous wireless networks, there will be no data loss or excessive transmission delay.

Still further, a streaming proxy is provided in the edge-computing platform. When the switch forwards data from the heterogeneous wireless networks to the application server, the streaming proxy performs source switching by assigning a common IP address that leads to no interruption or with low latency when transmitting the data to the application server during the handover process.

In conclusion, taking a WiFi™ network and a 4G/5G network as an example, the edge-computing device (e.g., also called a middlebox) that operates a switch and a streaming proxy is provided to integrate the WiFi™ network and the 4G/5G network. Specifically, the edge-computing device enables a video streaming server that regards the heterogeneous wireless networking data as a single source streaming data during a handover process performed in the in-vehicle device.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A system for integrating heterogeneous wireless networks, comprising:
an in-vehicle device that is installed in a vehicle and is configured to perform a handover process in response to a signal strength indicator between a first wireless connectivity and a second wireless connectivity, the first wireless connectivity being established for transmitting a first wireless networking data to an edge-computing device via a wireless access point, and the second wireless connectivity being established for transmitting a second wireless networking data to a mobile core control plane network via a mobile base station; and
the edge-computing device comprising:
a switch being configured to receive the first wireless networking data via a first wireless network interface and shift the second wireless networking data via a shifted connectivity to the edge-computing device from the mobile core control plane network via a second wireless network interface; wherein the switch performs network convergence on the first wireless networking data and the second wireless networking data so as to obtain a converged data;
a streaming proxy coupled with the switch and being configured to perform source switching on the converged data received from the switch without interruption during the handover process by assigning a common IP address to the converged data; and
a data bank being configured to store the converged data with the common IP address.

2. The system according to claim 1, wherein the edge-computing device is installed in a vehicle station and is used to establish the first wireless connectivity with the in-vehicle device for transmitting the first wireless networking data when the vehicle approaches the vehicle station.

3. The system according to claim 2, wherein the switch is configured to shift the second wireless networking data to the edge-computing device via the second wireless network interface when the vehicle approaches the vehicle station.

4. The system according to claim 3, wherein the second wireless network interface is implemented by a mobile data plane that is configured to shift the second wireless networking data to the edge-computing device from the mobile core control plane network.

5. The system according to claim 4, wherein the in-vehicle device includes a handover controller that performs the handover process between the first wireless connectivity and the second wireless connectivity in response to the signal strength indicator that is generated by detecting signal strength between the in-vehicle device and the wireless access point or the mobile base station.

6. The system according to claim 5, wherein the switch continuously receives both the first wireless networking data and the shifted second wireless networking data during the handover process since the first wireless connectivity and the shifted connectivity between the in-vehicle device and the edge-computing device coexist when the handover process is performed.

7. The system according to claim 6, wherein the handover process comprises steps of:
receiving data generated by one or more peripheral devices installed in the vehicle;
establishing the second wireless connectivity with the mobile base station for transmitting the data or a minority of items of data to the mobile core control plane network;
switching the second wireless connectivity to the first wireless connectivity with the wireless access point in response to the signal strength indicator indicating that the signal strength of the first wireless connectivity is higher than a prest threshold or the signal strength of the second wireless connectivity; and
transmitting the data to the edge-computing device over the first wireless connectivity.

8. The system according to claim 1, wherein the first wireless networking data is a first type of streaming packets being encapsulated in compliance with a first communication protocol, and the second wireless networking data is a second type of streaming packets being encapsulated in compliance with a second communication protocol, and wherein the first communication protocol and the second communication protocol are heterogeneous wireless network protocols.

9. The system according to claim 8, wherein the first communication protocol is a WiFi™ standard network protocol and the second communication protocol is a cellular communication protocol.

10. The system according to claim 8, wherein the switch is a software-defined networking switch that is configured to process heterogeneous wireless networking data.

11. A method for operating integration of heterogeneous wireless networks, comprising:
in an in-vehicle device, performing a handover process and establishing a second wireless connectivity with a mobile base station for transmitting data generated by one or more peripheral devices installed in a vehicle or a minority of items of the data to a mobile core control plane network;
in the handover process, switching the second wireless connectivity to a first wireless connectivity with a wireless access point in response to a signal strength indicator indicating that signal strength of the first wireless connectivity is higher than a preset threshold or signal strength of the second wireless connectivity;
in the in-vehicle device, transmitting the data to an edge-computing device over the first wireless connectivity;
in the edge-computing device, a switch receiving the first wireless networking data via a first wireless network interface and shifting the second wireless networking data via a shifted connectivity to the edge-computing device from the mobile core control plane network via a second wireless network interface;
in the switch, performing network convergence on the first wireless networking data and the second wireless networking data so as to obtain a converged data;
in a streaming proxy of the edge-computing device, performing source switching on the converged data received from the switch without interruption during the handover process by assigning a common IP address to the converged data; and
in the edge-computing device, storing the converged data with the common IP address to a data bank.

12. The method according to claim 11, wherein the edge-computing device is installed in a vehicle station and is used to establish the first wireless connectivity with the in-vehicle device for transmitting the first wireless networking data when the vehicle approaches the vehicle station.

13. The method according to claim 12, wherein, when the vehicle approaches the vehicle station, the edge-computing device establishes the shifted connectivity with the in-vehicle device for the switch to shift the second wireless networking data to the edge-computing device via the second wireless network interface during the handover process.

14. The method according to claim 13, wherein the second wireless network interface is implemented by a mobile data plane that is configured to shift the second wireless networking data to the edge-computing device from the mobile core control plane network.

15. The method according to claim 13, wherein the switch continuously receives both the first wireless networking data and the second wireless networking data during the handover process since both the first wireless connectivity and the shifted connectivity between the in-vehicle device and the edge-computing device coexist when the handover process is performed.

16. The method according to claim 11, wherein the first wireless networking data is a first type of streaming packets being encapsulated in compliance with a first communication protocol, and the second wireless networking data is a second type of streaming packets being encapsulated in compliance with a second communication protocol, and wherein the first communication protocol and the second communication protocol are heterogeneous wireless network protocols.

17. An edge-computing device, installed in a vehicle station, comprising:
a switch being configured to receive a first wireless networking data from an in-vehicle device installed in a vehicle via a first wireless network interface and a second wireless networking data that is transmitted by the in-vehicle device and is shifted via a shifted connectivity from a mobile core control plane network via a second wireless network interface; wherein the switch performs network convergence on the first wireless networking data and the second wireless networking data so as to obtain a converged data;
a streaming proxy coupled with the switch and being configured to perform source switching on the converged data received from the switch without interruption during a handover process performed by the in-vehicle device by assigning a common IP address to the converged data; and
a data bank being configured to store the converged data with the common IP address.

18. The edge-computing device according to claim 17, wherein the switch is a software-defined networking switch that is configured to process heterogeneous wireless networking data; and, through the switch of the edge-computing device, a first wireless connectivity with the in-vehicle device is established for transmitting the first wireless networking data when the vehicle approaches the vehicle station.

19. The edge-computing device according to claim 18, wherein the switch continuously receives both the first wireless networking data and the second wireless networking data during the handover process since both the first wireless connectivity and the shifted connectivity between the in-vehicle device and the edge-computing device coexist when the handover process is performed.

20. The edge-computing device according to claim 17, wherein the streaming proxy receives the converged data including the first wireless networking data with a first IP address and the second wireless networking data with a second IP address, and performs source switching on the converged data without interruption during the handover process by assigning a common IP address to the converged data.
